(19) United States
(12) Patent Application Publication
(10) Pub. No.: US 2013/0232084 A1
(43) Pub. Date: Sep. 5, 2013

(54) Mobile Financial Transaction System and Method

(71) Applicant: Saner Ates, Kocaeli (TR)

(72) Inventor: Saner Ates, Kocaeli (TR)

(73) Assignee: Turkcell Teknoloji Arastirma Ve Gelistirme Anonim Sirketi, Kocaeli (TR)

(21) Appl. No.: 13/807,285

(22) PCT Filed: Jan. 31, 2012
(86) PCT No.: PCT/IB12/50450

§ 371 Date: Dec. 27, 2012

(30) Foreign Application Priority Data
Sep. 30, 2011 (TR) 2011/09705

(51) Int. Cl. G06Q 20/32

(52) U.S. Cl. CPC G06Q 20/3229
USPC 705/67

(57) ABSTRACT

The present invention relates to a mobile financial transaction system (1) and method (100) which is operated on mobile device (3) and enables user information to be carried on SIM card (2) by being encrypted. With the inventive system (1) and method (100), the user can carry out his/her financial transactions on the bank (B) desired.

### TECHNICAL FIELD

The present invention relates to a mobile financial transaction system and method which enables mobile device users to carry out their financial transactions securely by means of their mobile devices.

### BACKGROUND OF THE INVENTION

Today, importance of using mobile devices such as mobile phones, smart phones for carrying out basic financial transactions increases with each passing day. There are millions of people who have mobile device although do not have bank account in the world. Operators providing service to mobile devices do researches about providing the said service to mobile device users in order to meet market requirements. Within this scope, a trading volume of seventy billion U.S. dollar was realized in 2009 worldwide. So as to provide the said service, operators configure flow according to circumstances allowed by regulation in two ways:
in countries such as Central and Southern African countries where banking regulation and rules are not set entirely, operators carry out transactions of raising money, opening account and transferring money for customers using their own branch networks; and
over common platforms of banks and operators in countries where banking rules are set and have no e-money license.

Nowadays, banking and financial transactions are carried out using channels such as bank, post office branches, internet branches, mobile applications. Using bank and post office branches in these transactions both limit people in terms of time and location and composes employee and system costs for banks. Internet and mobile applications of banks both obligate customers to use internet and put them into trouble by scenarios which are encountered in terms of security sometimes, and lead to bank addiction because they are platforms which are prepared only by the related bank. For example, in money transfers, internet and mobile applications either allow only transactions between customers of the same bank for 24/7 or make it obligatory that transaction is carried out according to existing electronic funds transfer (EFT) legislation if there will be transfer to other banks. While these transactions are being carried out via internet and mobile applications, customers are expected to enter a password which is created new or their card passwords together with a data such as account number, customer number expressing customers' accounts. These data are protected by secure sockets layer (SSL) certificates during transfer if internet will be used.

The United States patent document no. US2010/0131764 discloses a secure system and method of exchanging information and carrying out transaction over public telecommunications network. The said system and method particularly relates to carrying out transactions related to secured information such as banking, making payment. With the said system, it is ensured that information is exchanged between mobile devices such as phone, PDA, etc. and back-end host securely. The said information flow is carried out over a plurality of hops and points having exchange of password with HSM without any software security gaps in between servers. In an example of a secured banking service, a midlet which is installed on the mobile device synchronizes and communicates with an application or gateway server and then connects to financial institutions/merchants/banks in order to carry out financial transactions over network.

### SUMMARY OF THE INVENTION

Objective of the invention is to realize a mobile financial transaction system and method which is operated on mobile device and enables user information to be carried on SIM card (2) by being encrypted.

### DETAILED DESCRIPTION OF THE INVENTION

“Mobile Financial Transaction System and Method” realized to fulfill the objective of the present invention is shown in the figures attached, in which:

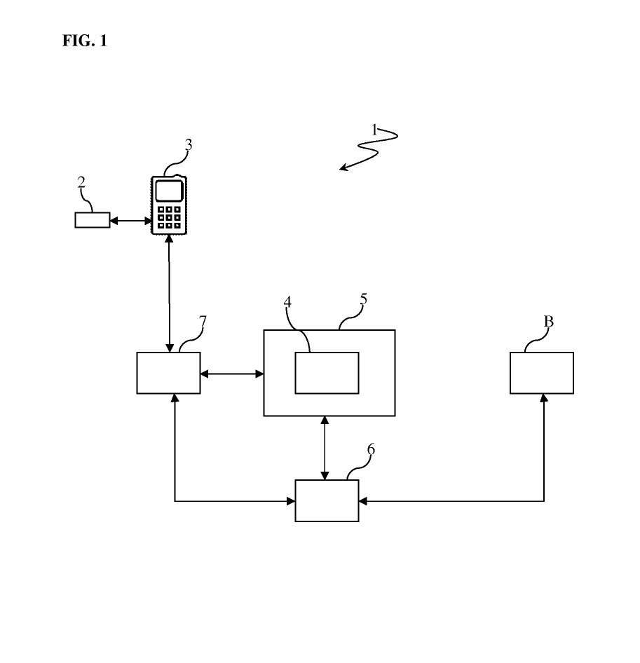

FIG. 1 is a schematic view of the inventive mobile financial transaction system.

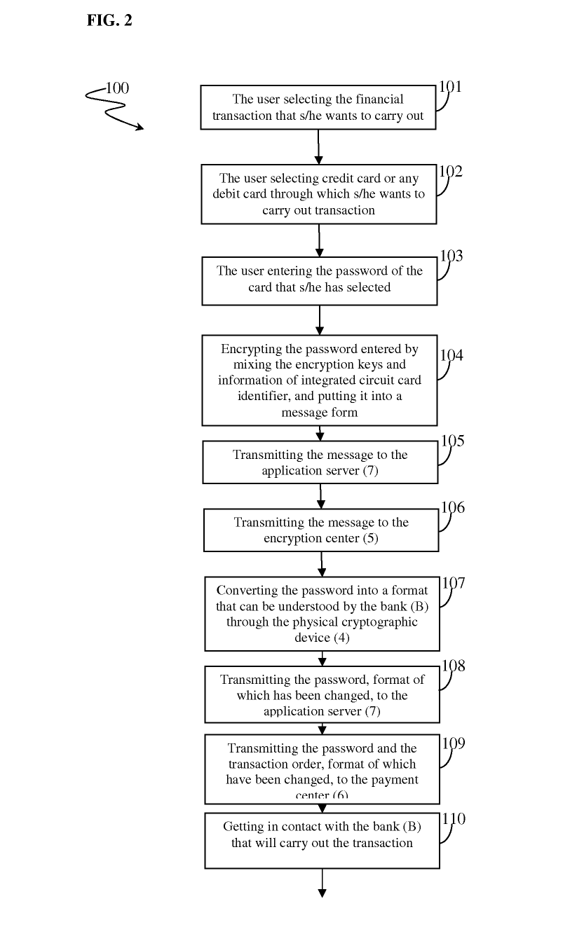

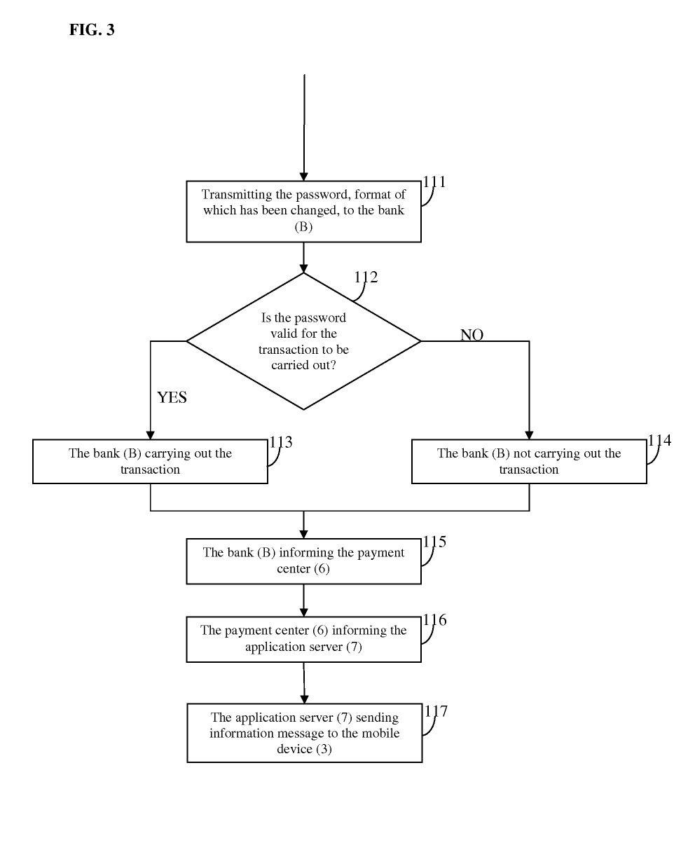

FIG. 2 is a flow diagram of the inventive mobile financial transaction method.

FIG. 2 is continuation of the flow diagram in the FIG. 2 concerning the inventive mobile financial transaction method.

The components illustrated in the figures are individually numbered, where the numbers refer to the following:

1. Mobile financial transaction system

2. SIM card

3. Mobile device

4. Physical cryptographic device

5. Encryption center

6. Payment center

7. Application server

100. Mobile financial transaction method

B: Bank

The inventive mobile financial transaction system (1) comprises:
at least one mobile device (3) which has at least one SIM card (2) providing connection to GSM network, enables financial transaction order to be given by the user and message in which there is at least one password to be sent;
at least one encryption center (5) which has at least one physical cryptographic device (hardware security module_HSM) (4) enabling the password in the message received from the mobile device (3) to be converted into a format that can be verified by the bank (B);
at least one payment center (6) which enables to get in contact with the bank (B) where it is desired to carry out transaction; and
at least one application server (7) which transmits the message received from the mobile device (3) to the encryption center (5), connects and gives order to the payment center (6) so that the transaction is carried out after the encryption center (5) converts the password in the message into a format that can be verified by the bank (B), and notifies the mobile device (3) of the user about the transaction result via a message.

The SIM card (2) enables the mobile device (3) to get service from a GSM network. The

SIM card (2) provided in the inventive mobile financial transaction system (1) comprises a special encryption key. In a preferred embodiment of the invention, 3DES encryption method is used as encryption key. Password of credit card or any debit card entered to the mobile device (3) by the user in order to carry out transaction is encrypted by means of the said encryption keys. The card password is obtained as a result of mixing the information of integrated circuit card identifier (ICCID) of the SIM card (2) with the encryption key included in the SIM card (2).

The mobile device (3) might be any device in which the SIM card (2) can be inserted and can connect to GSM network such as a mobile phone, a smart phone, a portable computing device. By means of the mobile device (3), the user selects the financial transaction that s/he wants to carry out and the credit card or any debit card through which s/he wants to carry out the financial transaction. The user also enters the password of the credit card or any debit card to the system (1) by means of the mobile device (3) in order to start the transaction. In a preferred embodiment of the invention, the user selects the financial transaction that s/he wants to carry out from the SIM card (2) menu. After the user enters the password of the credit card or any debit card, the said password is encrypted by the SIM card (2) securely such that it will not be understood by anyone. This new password obtained is sent from the mobile device (3) to the application server (7) via a message. In a preferred embodiment of the invention, the message sent from the mobile device (3) to the application server (7) has a short message (SMS) format.

The encryption center (5) converts the password in the message, which is sent to it from the application server (7) and includes the password set by the SIM card (2), into a format that can be verified by the bank (B) by means of the physical cryptographic device (4) owned.

By means of the physical cryptographic device (4), the message including password set by the SIM card (2) is converted into a format that can be verified by the bank (B). Key data special for the bank (B) and the SIM card (2) manufacturer are input into the physical cryptographic device (4) by them in advance. Thus, the physical cryptographic device (4) converts the password encrypted by the SIM card (2) into a format that can be verified by the bank (B). The password converted into a format that can be verified by the bank (B) by means of the physical cryptographic device (4) is sent from the physical cryptographic device (4) to the application server (7).

The payment center (6) gets in contact with the bank (B) where the user wants to carry out transaction, by order of the application server (7). The password converted into a format that can be verified by the bank (B) by means of the physical cryptographic device (4) is transmitted to the bank (B) after the payment center (6) gets in contact with the bank (B). And the bank (B) controls accuracy of the password reaching it and carries out the transaction or not according to result of the control. The bank (B) informs the payment center (6) about whether it carried out the transaction or not.

The application server (7) receives the message received from the mobile device (3) and including the password set by the SIM card (2) and transmits the said message to the encryption center (5) in order that it converts it into a format to be verified by the bank (B). The password, which is converted into a format that can be verified by the bank (B) by means of the physical cryptographic device (4) in the encryption center (5), is sent back to the application server (7) from the encryption center (5). The application server (7) transmits the password, which is received from the encryption center (5), to the payment center (6) together with the demand of getting in contact with the bank (B). The payment center (6) transmits the information whether the bank (B) has carried out the transaction or not to the application server (7). In accordance with the information received from the payment center (6), the application server (7) sends message to the mobile device (3) concerning whether the transaction is carried out or not. In a preferred embodiment of the invention, the message sent from the application server (7) to the mobile device (3) has a short message (SMS) format.

The mobile financial transaction method (100) enabling mobile device (3) users to carry out their financial transactions securely by means of their mobile devices (3) comprises steps of:
the user selecting the financial transaction that s/he wants to carry out by means of his/her mobile device (3) (101);
the user selecting one of the credit card or other debit cards through which s/he wants to carry out the financial transaction by means of his/her mobile device (3) (102);
the user entering the password of the card that s/he has selected into the mobile device (3) (103);
encrypting password of one of the credit card or other debit cards input by the user such that it will not be understood by anyone by mixing it with the information of integrated circuit card identifier (ICCID) and the encryption keys, and putting it into a message form by means of the SIM card (2) (104);
transmitting the message, which includes the password, from the mobile device (3) to the application server (7) over GSM network (105);
transmitting the password, in the message reaching the application server (7), from the application server (7) to the encryption center (5) (106);
converting the password into a format that can be verified by the bank (B) by the physical cryptographic device (4) in the encryption center (5) (107);
transmitting the password, which is converted into a format that can be verified by the bank (B), to the application server (7) (108);
transmitting the order of password and starting transaction to the payment center (6) by means of the application server (7) (109);
the payment center (6) getting in contact with the bank (B) where the user wants to carry out transaction (110);
the payment center (6) transmitting the password to the bank (B) (111);
the bank (B) controlling validity of the password (112);
if the password is valid, the bank (B) carrying out the transaction desired by the user (113);
if the password is invalid, the bank (B) not carrying out the transaction desired by the user (114);
the bank (B) informing the payment center (6) concerning whether the transaction is carried out or not (115);
the payment center (6) informing the application server (7) (116); and
sending information message to the mobile device (3) by the application server (7) concerning whether the transaction is carried out by the bank (B) or not (117).

In the inventive mobile financial transaction method (100), the user selects type of financial transaction that s/he wants to carry out from the SIM card (2) menu provided in his/her mobile device (3) (101) at first. Then, the user selects which one of the debit card or credit cards defined to the SIM card (2) menu previously by him/her that s/he wants to use in order to carry out the financial transaction selected (102) and enters the password of the card selected into the mobile device (3) by means of the mobile device (3) (103). Password of the credit card or any debit card input into the system is mixed with the encryption keys and information of integrated circuit card identifier (ICCID) provided in the system such that nobody will understand the password, and it is put into a message form so as to be sent to the application server (7) (104). The message which includes the password is transmitted to the application server (7) by the mobile device (3) (105). In order that the password in the message reaching itself is converted into a format that can be verified by the bank (B), the application server (7) transmits the password to the encryption center (5) (106). The password reaching the encryption center (5) is converted into a format that will be understood by the bank (B) by means of the physical cryptographic device (4) (107). The password converted into a format that will be understood by the bank (B) is transmitted from the encryption center (5) back to the application server (7) (108). The application server (7) transmits the password received from the encryption center (5) to the payment center (6) together with the order of starting transaction (109). In accordance with the order received from the application server (7), the payment center (6) ensures that it is get in contact with the bank (B) where the user wants to carry out transaction (110). After it is get in contact with the bank (B), the payment center (6) transmits the password reaching itself from the application server (7) to the bank (B) (111). The bank (B) controls validity of the password received from the payment center (6) in its own system (112). If the bank (B) determines that the password reaching itself is correct it carries out the financial transaction desired by the user (113). If the bank (B) determines that the password reaching itself is wrong it does not carry out the financial transaction desired by the user (114). After the transaction is carried out (113) or not (114) by the bank (B), the bank (B) informs the payment center (6) concerning the last status of the transaction in other words whether the transaction is carried out or not (115). And the payment center (6) transmits the information reaching itself from the bank (B) to the application server (7) (116). In accordance with the notice made to it from the payment center (6), the application server (7) sends message to the mobile device (3) over GSM network concerning the last status of the transaction in other words whether the transaction is carried out by the bank (B) or not (117).

At the step of encrypting password of one of the credit card or other debit cards input by the user such that it will not be understood by anyone by mixing it with the information of integrated circuit card identifier (ICCID) and the encryption keys, and putting it into a message form (104) provided in the inventive mobile financial transaction method by means of the SIM card (2) (100), the card password input by the user is encrypted with an encryption key produced special for the SIM card (2) using preferably standard 3DES encryption method. The password created at the said step is set by mixing the integrated circuit card identifier of the SIM card (2) and the encryption keys placed into the SIM card (2) by the producing company, preferably 3DES keys.

At the step of transmitting the message, which includes the password, from the mobile device (3) to the application server (7) over GSM network (105) provided in the inventive mobile financial transaction method (100), the message sent to the application server (7) by the mobile device (3) preferably has a short message (SMS) format.

At the step of converting the password into a format that can be verified by the bank (B) by the physical cryptographic device (4) in the encryption center (5) (107) provided in the inventive mobile financial transaction method (100), the bank (B) and SIM card (2) manufacturer input key data which are special for them into the physical cryptographic device (4) in advance. Thus, the physical cryptographic device (4) converts the password encrypted by the SIM card (2) into a format that can be verified by the bank (B).

At the step of sending information message to the mobile device (3) by the application server (7) concerning whether the transaction is carried out by the bank (B) or not (117) provided in the inventive mobile financial transaction method (100), the message sent from the application server (7) to the mobile device (3) preferably has a short message (SMS) format.

It is possible to develop various embodiments of the inventive mobile financial transaction system (1) and method (100), it cannot be limited to examples disclosed herein and it is essentially according to claims.

1. A mobile financial transaction system (1) comprising at least one mobile device (3) which has at least one SIM card (2) providing connection to a GSM network, enables a financial transaction order to be given by a user and a message in which there is at least one password to be sent; characterized by
at least one encryption center (5) which has at least one physical cryptographic device (hardware security module_HSM) (4) enabling the password in the message received from the mobile device (3) to be converted into a format that can be verified by a bank (B);
at least one payment center (6) which enables getting in contact with the bank (B) where it is desired to carry out the transaction; and
at least one application server (7) which transmits the message received from the mobile device (3) to the encryption center (5), connects and gives order to the payment center (6) in order that the transaction is carried out after the encryption center (5) converts the password in the message into a format that can be verified by the bank (B), and notifies the mobile device (3) of the user about the transaction result via a message.

2. A mobile financial transaction system (1) according to claim 1, characterized by the mobile device (3) which enables the user to select the financial transaction that the user wants to carry out, a credit card or any debit card through which the user wants to carry out the financial transaction.

3. A mobile financial transaction system (1) according to claim 2, characterized by the mobile device (3) which enables the user to enter a password of the credit card or any debit card in order to start the transaction.

4. A mobile financial transaction system (1) according to claim 2, characterized by the mobile device (3) which enables the user to select the financial transaction that the user wants to carry out from a SIM card (2) menu.

5. A mobile financial transaction system (1) according to claim 1, characterized by the SIM card (2) which comprises special encryption keys.

6. A mobile financial transaction system (1) according to claim 5, characterized by the encryption key which uses a 3DES encryption method.

7. A mobile financial transaction system (1) according to claim 5, characterized by the encryption keys which enable to encrypt the password of the credit card or any debit card entered to the mobile device (3) by the user in order to carry out the transaction.

8. A mobile financial transaction system (1) according to claim 7, characterized by the password which is obtained as a result of mixing the information of an integrated circuit card identifier of the SIM card (2) with the encryption keys included in the SIM card (2).

9. A mobile financial transaction system (1) according to claim 8, characterized by the mobile device (3) which sends the password created by the SIM card (2) to the application server (7) via a message.

10. A mobile financial transaction system (1) according to claim 9, characterized by the message which has a short message (SMS) format.

11. A mobile financial transaction system (1) according to claim 1, characterized by the physical cryptographic device (4) into which key data, special for the bank (B) and the SIM card (2) manufacturer are input by them in advance in order that the password encrypted by the SIM card (2) is converted into a format that can be verified by the bank (B).

12. A mobile financial transaction method (100) which enables mobile device users to carry out their financial transactions securely by means of their mobile devices characterized by steps of:
the user selecting a financial transaction that the user wants to carry out by means of the user's mobile device (3) (101);
the user selecting one of a credit card or other debit cards through which the user wants to carry out the financial transaction by means of the user's mobile device (3) (102);
the user entering a password of the card that the user has selected into the mobile device (3) (103);
encrypting the password of one of the credit card or other debit cards input by the user such that it will not be understood by anyone by mixing it with the information of an integrated circuit card identifier (ICCID) and encryption keys, and putting it into a message form by means of a SIM card (2) (104);
transmitting the message, which includes the password, from the mobile device (3) to an application server (7) over a GSM network (105);
transmitting the password, in the message reaching the application server (7), from the application server (7) to an encryption center (5) (106);
converting the password into a format that can be verified by a bank (B) by a physical cryptographic device (4) in the encryption center (5) (107);
transmitting the password, which is converted into a format that can be verified by the bank (B), to the application server (7) (108);
transmitting the order of password and starting the transaction to a payment center (6) by means of the application server (7) (109);
the payment center (6) getting in contact with the bank (B) where the user wants to carry out the transaction (110);
the payment center (6) transmitting the password to the bank (B) (111);
the bank (B) controlling validity of the password (112);
if the password is valid, the bank (B) carrying out the transaction desired by the user (113);
if the password is invalid, the bank (B) not carrying out the transaction desired by the user (114);
the bank (B) informing the payment center (6) concerning whether the transaction is carried out or not (115);
the payment center (6) informing the application server (7) (116); and
sending an information message to the mobile device (3) by the application server (7) concerning whether the transaction is carried out by the bank (B) or not (117).

13. A mobile financial transaction method (100) according to claim 12, characterized by the step of encrypting a password of one of the credit card or other debit cards input by the user such that it will not be understood by anyone by mixing it with the information of the integrated circuit card identifier (ICCID) and the encryption keys, and putting it into a message form by means of the SIM card (2) (104) wherein the card password entered by the user is encrypted by an encryption key generated special for the SIM card (2).

14. A mobile financial transaction method (100) according to claim 13, characterized by the step of encrypting the password of one of the credit card or other debit cards input by the user such that it will not be understood by anyone by mixing it with the information of the integrated circuit card identifier (ICCID) and the encryption keys, and putting it into a message form by means of the SIM card (2) (104) wherein the card password entered by the user is encrypted using a 3DES encryption method.

15. A mobile financial transaction method (100) according to claim 13, characterized by the step of encrypting the password of one of the credit card or other debit cards input by the user such that it will not be understood by anyone by mixing it with the information of the integrated circuit card identifier (ICCID) and the encryption keys, and putting it into a message form by means of the SIM card (2) (104) wherein the password is created by mixing the integrated circuit card identifier of the SIM card (2) and the encryption keys input into the SIM card (2) by a manufacturer.

16. A mobile financial transaction method (100) according to claim 12, characterized by the step of delivering the message, which includes the password, from the mobile device (3) to the application server (7) over the GSM network (105) wherein the message sent to the mobile device (3) by the application server (7) has a short message (SMS) format.

17. A mobile financial transaction method (100) according to claim 12, characterized by the step of sending an information message to the mobile device (3) by the application server (7) concerning whether the transaction is carried out by the bank (B) or not (117) wherein the message sent from the application server (7) to the mobile device (3) has a short message (SMS) format.

18. A mobile financial transaction method (100) according to any of claim 16, characterized by the step of sending an information message to the mobile device (3) by the application server (7) concerning whether the transaction is carried out by the bank (B) or not (117) wherein the message sent from the application server (7) to the mobile device (3) has a short message (SMS) format.

19. A mobile financial transaction system (1) according to claim 3, characterized by the mobile device (3) which enables the user to select the financial transaction that the user wants to carry out from a SIM card (2) menu.

20. A mobile financial transaction method (100) according to claim 14, characterized by the step of encrypting the password of one of the credit card or other debit cards input by the user such that it will not be understood by anyone by mixing it with the information of the integrated circuit card identifier (ICCID) and the encryption keys, and putting it into a message form by means of the SIM card (2) (104) wherein the password is created by mixing the integrated circuit card identifier of the SIM card (2) and the encryption keys input into the SIM card (2) by a manufacturer.
